(19) United States
(12) Patent Application Publication
(10) Pub. No.: US 2022/0122481 A1
(43) Pub. Date: Apr. 21, 2022

(54) User Knowledge Tracking Device, System, and Operation Method thereof Based on Artificial Intelligence Learning

(71) Applicant: RIIID INC., Seoul (KR)

(72) Inventors: Dong Min SHIN, Seoul (KR); Yu Geun SHIM, Seoul (KR); Han Gyeol YU, Seoul (KR); See Woo LEE, Chungcheongbuk-do (KR); Byung Soo KIM, Seoul (KR); Young Duck CHOI, Seoul (KR)

(21) Appl. No.: 17/503,103

(22) Filed: Oct. 15, 2021

(30) Foreign Application Priority Data
Oct. 15, 2020 (KR) 10-2020-0133309
Aug. 31, 2021 (KR) 10-2021-0115659

(51) Int. Cl. G09B 7/06; G06N 7/00; G06N 5/02

(52) U.S. Cl. CPC G09B 7/06; G06N 5/022; G06N 7/00

(57) ABSTRACT

A user knowledge tracking device is provided. The user knowledge tracking device use a transformer structure-based artificial intelligence model as a knowledge tracking model which is trained by inputting exercise information to an encoder thereof and inputting response information to a decoder thereof so as to predict a user's correct answer probability based on the trained knowledge tracking model.

### CROSS-REFERENCE TO RELATED APPLICATION(S)

This application claims priority from Korean Patent Application No. 10-2020-0133309, filed on Oct. 15, 2020 and Korean Patent Application No. 10-2021-0115659, filed on Aug. 31, 2021 in the Korean Intellectual Property Office, the disclosure of which is incorporated herein its entirety.

### BACKGROUND

### 1. Field

The present disclosure relates to a user knowledge tracking device, a system, and an operation method thereof based on artificial intelligence learning. More specifically, the present disclosure relates to a transformer structure-based artificial intelligence model as a knowledge tracking model which is trained by inputting exercise information to an encoder thereof and inputting response information to a decoder thereof so as to predict a user's correct answer probability based on the trained knowledge tracking model.

### 2. Discussion of Related Art

Recently, the use of the Internet and electronic devices has been actively conducted in various fields, and the educational environment is also changing rapidly. In particular, with the development of various educational media, learners may choose and use a wider range of learning methods. Among these learning methods, education services through the Internet have been positioned as a major teaching and learning method because of the advantage of overcoming time and space constraints and enabling low-cost education.

In response to these trends, customized education services, which cannot be achieved in offline education due to limited human and material resources, are also diversifying. For example, by using artificial intelligence to provide subdivided educational content according to personalities and abilities of learners, the educational content is provided according to individual competency of the learners, breaking away from the uniform education method of the past.

The knowledge tracking model is an artificial intelligence model that models knowledge acquisition levels of students based on learning flow lines of the students. Specifically, when records including exercises solved by students and students' responses to these exercises are provided, the artificial intelligence model means predicting a probability that the students will answer subsequent given exercises correctly.

Most of the existing deep learning-based knowledge tracking models predict correct and incorrect answers of students by focusing on exercises or concept(s) corresponding to the exercises, and by focusing on whether the students have answered the exercises correctly. However, time information related to students' responses, such as how long it took students to solve exercises and how much time has elapsed since the students responded to previous exercises, may be regarded as essential information for tracking knowledge states of the students and predicting correct and incorrect answers with higher accuracy.

For example, when a student answers a particular exercise correctly but took a long time to solve the exercise, it may not be said that the student understands the exercise well. In addition, when it has been a long time since a student studied exercises of particular concepts, although the student has answered a number of related exercises correctly before, when the student solves exercises with the same concept at present, there is a probability that the student will forget the concept and answer the exercises incorrectly.

Models that do not use time information on the response may not identify these exercises, and therefore, prediction accuracy of the models is inevitably lower than that of models that use time information.

### SUMMARY

An aspect of the present disclosure is provided to a user knowledge tracking device, a system, and an operation method thereof capable of predicting a correct answer probability with higher accuracy by predicting the correct answer probability based on a trained artificial intelligence model by inputting exercise information to an encoder and response information to a decoder in a transformer structure-based artificial neural network.

In addition, another aspect of the present disclosure is provide to a user knowledge tracking device, a system, and an operation method thereof capable of predicting a correct answer probability to a particular exercise with higher accuracy by training an artificial intelligence model based on time information related to a user's response such as a time it takes a user to solve an exercise and a lag time from solving a previous exercise to solving a subsequent exercise.

Further, another aspect of the present disclosure is provide to a user knowledge tracking device, a system, and an operation method thereof capable of predicting a correct probability more efficiently by determining an embedding method of time information based on parameters extracted from exercise information and response information, such as the average number of exercises solved by a user and an average and variance value of collected time information distribution.

Additional aspects of the present disclosure are not limited to the above-described aspects. That is, other aspects that are not described may be obviously understood by those skilled in the art from the following specification.

In accordance with an aspect of the disclosure, a user knowledge tracking device for predicting a correct answer probability using time information related to exercise solving includes an exercise-response information storage unit configured to store exercise-response information that includes exercise information provided to a user for learning and response information to a solving record for an exercise solved by the user, an embedding performing unit configured to receive the response information from the exercise-response information storage unit and perform embedding on time information included in the response information, and a model training unit configured to input an embedded exercise information and response information and adjust a weight indicating a relationship between the time information included in the response information and a user's correct answer probability to train the knowledge tracking model for predicting a user's correct answer probability for an exercise that the user has not yet solved based on the weight.

In accordance with another aspect of the disclosure, an operation method of a user knowledge tracking device for predicting a correct answer probability using time information related to exercise solving includes storing exercise-response information, which includes exercise information provided to a user for learning and response information to a solving record for an exercise solved by the user in an exercise-response information storage unit, receiving the response information from the exercise-response information storage unit and performing embedding on time information included in the response information, and inputting an embedded exercise information and response information to a knowledge tracking model and adjusting a weight indicating a relationship between the time information included in the response information and a user's correct answer probability to train the knowledge tracking model for predicting a user's correct answer probability for an exercise that the user has not yet solved based on the weight.

Detailed contents of other embodiments are described in a detailed description and are illustrated in the accompanying drawings.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram for describing a configuration of a user knowledge tracking system according to an embodiment of the present disclosure;

FIG. 2 is a block diagram for describing a configuration of a user terminal according to an embodiment of the present disclosure;

FIG. 3 is a block diagram for describing a configuration of a user knowledge tracking device according to an embodiment of the present disclosure;

FIG. 4 is a diagram for describing an elapse time and a lag time according to an embodiment of the present disclosure;

FIG. 5 is a diagram for describing an operation of a transformer structure-based artificial neural network according to an embodiment of the present disclosure;

FIG. 6 is a diagram for describing key-query masking and upper triangular masking; and

FIG. 7 is a flowchart for describing an operation of the user knowledge tracking device according to the embodiment of the present disclosure.

### DETAILED DESCRIPTION

Various advantages and features of the present disclosure and methods accomplishing them will become apparent from embodiments to be described in detail below with reference to the accompanying drawings. However, the present disclosure is not limited to embodiments to be described below but may be implemented in various different forms, these exemplary embodiments will be provided only in order to make the present disclosure complete and allow those skilled in the art to completely recognize the scope of the present disclosure, and the present disclosure will be defined by the scope of the claims.

Unless defined otherwise, all terms (including technical and scientific terms) used in the present specification have the same meaning as meanings commonly understood by those skilled in the art to which the present disclosure pertains. In addition, terms defined in commonly used dictionaries are not ideally or excessively interpreted unless explicitly defined otherwise.

Terms used in the present disclosure are for describing exemplary embodiments rather than limiting the present disclosure. Unless otherwise stated, a singular form includes a plural form in the present specification. Throughout this specification, the terms “comprise” and/or “comprising” will be understood to imply the inclusion of stated constituents but not the exclusion of any other constituents.

In describing embodiments in the present specification, it is to be understood that when one component is referred to as being “connected to” or “coupled to” another component, one component may be connected directly to or coupled directly to another component or may be connected to or coupled to another component with the other component interposed therebetween.

Hereinafter, exemplary embodiments of the present disclosure will be described with reference to the accompanying drawings. In the drawings, like reference numbers indicate like components.

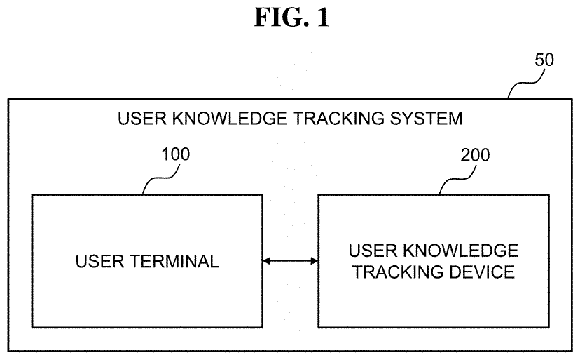

FIG. 1 is a diagram for describing an operation of a user knowledge tracking system according to an embodiment of the present disclosure.

Referring to FIG. 1, a user knowledge tracking system 50 may include a user terminal 100 and a user knowledge tracking device 200.

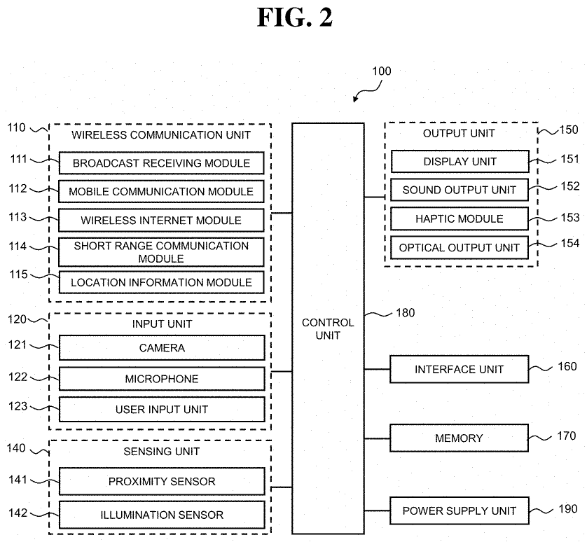

The user terminal 100 displays exercises to be solved by a user. In this case, the exercises to be solved by the user may be provided from the user knowledge tracking device 200 or may be provided from a separate external device (not illustrated). When a predetermined exercise among the displayed exercises is solved by the user, the user terminal 100 transmits response information including a record of a response to the exercise solved by the user to the user knowledge tracking device 200. The configuration of the user terminal 100 will be described later with reference to FIG. 2.

The user knowledge tracking device 200 may receive response information including the record of the response to the exercise solved by the user from the user terminal 100. Thereafter, the user knowledge tracking device 200 may train a knowledge tracking model based on the exercise information and response information which are pieces of information on the exercise solved by the user. The trained knowledge tracking model may be used to predict a user's correct answer probability for a given exercise when the user is given an arbitrary exercise that the user has not yet solved. The user's correct answer probability for the given exercise means the probability of getting a correct answer when the user solves the given exercise.

The conventional deep learning-based knowledge tracking model pays attention only to an exercise and a student's response when predicting a student's correct answer probability for a predetermined exercise. That is, the conventional deep learning-based knowledge tracking model does not take into account information related to a student's response time, such as how long it takes a student to solve an exercise and how much time has elapsed since the student completed solving a previous exercise.

Since the conventional knowledge tracking model does not reflect learning characteristics over time, such as a student's ability according to the time it takes to solve the exercise, and user's characteristic of forgetting learning content over time, there is a problem in that the correctness of the correct answer probability is lowered.

The present disclosure is devised to solve such a problem. The user knowledge tracking device 200 according to the embodiment of the present disclosure may predict the correct answer probability with higher accuracy by using a transformer structure-based artificial intelligence model trained based on response information to which time information is reflected.

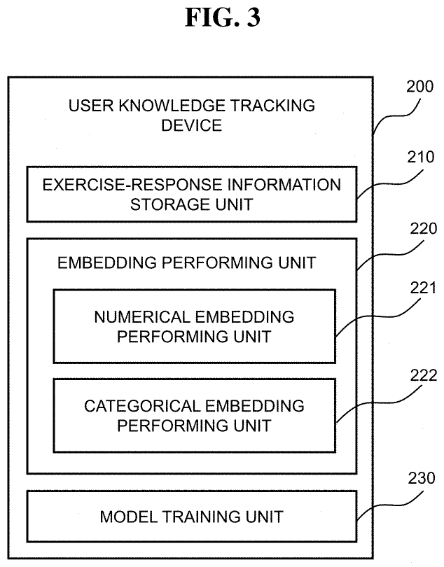

According to the embodiment of the present disclosure, the transformer structure-based artificial intelligence model may include an encoder and a decoder. The artificial intelligence model may be trained by inputting exercise information to the encoder of the artificial intelligence model and inputting response information to the decoder. Then, based on a weight determined as a result of the training, the user's correct answer probability for an arbitrary exercise that the user has not yet solved may be predicted. A more detailed description of the configuration of the user knowledge tracking device 200 and the transformer structure-based artificial intelligence model will be described later with reference to FIGS. 3 to 6.

FIG. 2 is a diagram for describing a configuration of a user terminal 100 according to an embodiment of the present disclosure.

Referring to FIG. 2, the user terminal 100 includes a wireless communication unit 110, an input unit 120, a sensing unit 140, an output unit 150, an interface unit 160, a memory 170, a control unit 180, and a power supply unit 190, and the like. The components illustrated in FIG. 2 are not essential to implementing the user terminal 100, and therefore, the user terminal 100 described herein may have more or fewer components than those listed above.

More specifically, the wireless communication unit 110 of the components may include one or more modules which enable wireless communication between the user terminal 100 and a wireless communication system, between the user terminal 100 and other user terminals 100, or between the user terminal 100 and an external server. In addition, the wireless communication unit 110 may include one or more modules which connect the user terminal 100 to one or more networks.

The wireless communication unit 110 may include at least one of a broadcast receiving module 111, a mobile communication module 112, a wireless Internet module 113, a short range communication module 114, and a position information module 115.

The input unit 120 may include a camera 121 or an image input unit for inputting an image signal, a microphone 122 or an audio input unit for inputting an audio signal, and a user input unit 123 for receiving information from a user. The user input unit 123 may include a touch key, a mechanical key, and the like. Voice data or image data collected by the input unit 120 may be analyzed and processed as a control command of a user.

The sensing unit 140 may include one or more sensors for sensing at least one of information of the user terminal 100, surrounding environment information surrounding the user terminal 100, and user information. For example, the sensing unit 140 may include one or more of a proximity sensor 141, an illumination sensor 142, a touch sensor, an acceleration sensor, a magnetic sensor, a gravity-sensor (G-gravity), a gyroscope sensor, a motion sensor, a red/green/blue (RGB) sensor, an infrared sensor (IR sensor), a fingerprint scan sensor, an ultrasonic sensor, and an optical sensor. Pieces of information sensed by two or more of the exemplified sensors may be combined and utilized.

The output unit 150 is for generating an output related to visual, auditory, or tactile sense. The output unit 150 may include one or more of a display unit 151, a sound output unit 152, a haptic module 153, and an optical output unit 154. The display unit 151 forms a layer structure with the touch sensor or is integrally formed with the touch sensor, thereby implementing a touch screen. The touch screen may function as the user input unit 123, which provides an input interface between the user terminal 100 and the user, and may provide an output interface between the user terminal 100 and the user.

The interface unit 160 serves as a path for various types of external devices connected to the user terminal 100. The interface unit 160 may include one or more of a wired/wireless headset port, an external charger port, a wired/wireless data port, a memory card port, a port for connection of a device including an identity module, an audio input/output port, a video input/output port, and an earphone port. In the user terminal 100, appropriate control related to the connected external device may be performed in response to the connection of the external device to the interface unit 160.

In addition, the memory 170 stores data supporting various functions of the user terminal 100. The memory 170 may store a plurality of application programs or applications that are driven by the user terminal 100, and data and instructions for operating the user terminal 100. At least some of these application programs may be downloaded from the external server via the wireless communication. In addition, at least some of these application programs may exist on the user terminal 100 from the time of shipment for basic functions (for example, a call incoming function, a call outgoing function, a message receiving function, and a message sending function) of the user terminal 100. Meanwhile, the application program may be stored in the memory 170, installed on the user terminal 100, and driven by the control unit 180 to perform the operation or function of the user terminal 100.

In addition to the operation related to the application program, the control unit 180 typically controls the overall operation of the user terminal 100. The control unit 180 may provide or process appropriate information or a function to a user by processing signals, data, information, and the like, which are input or output through the above-described components, or by driving the application program stored in the memory 170.

In addition, the control unit 180 may control at least some of the components described with reference to FIG. 2 to drive the application program stored in the memory 170. In addition, the control unit 180 may operate at least two or more of the components included in the user terminal 100 in combination with each other to drive the application program.

The power supply unit 190 receives external power and internal power under the control of the control unit 180 and supplies power to each component included in the user terminal 100. The power supply unit 190 includes a battery which may be a built-in battery or a replaceable battery.

FIG. 3 is a block diagram for describing a configuration of the user knowledge tracking device 200 according to the embodiment of the present disclosure.

Referring to FIG. 3, the user knowledge tracking device 200 may include an exercise-response information storage unit 210, an embedding performing unit 220, and a model training unit 230.

The exercise-response information storage unit 210 may store exercise-response information. The exercise-response information may include exercise information and response information.

The exercise information includes information on an exercise provided to the user terminal 100 for a user's learning. More specifically, the exercise information may include an exercise number, concepts related to the corresponding exercise, and fingerprint information of the corresponding exercise. However, this is only an example, and the exercise information may further include a variety of pieces of information that may express an exercise.

The response information includes information on a solving record for an exercise input by the user in the process of solving the exercise. More specifically, the response information may include information on whether an answer to an exercise is correct or incorrect, the time it takes a user to solve an exercise, a choice selected by a user from multiple choices, and information on platforms (web and mobile) on which an exercise is solved. However, this is only an example, and the response information may further include various types of information related to a user's exercise solving.

The exercise-response information storage unit 210 may update exercise information and response information whenever a user solves an exercise.

The embedding performing unit 220 may receive response information from the exercise-response information storage unit 210 and perform embedding on time information included in the response information. The time information refers to time information related to a user's response to an exercise.

The user knowledge tracking system 50 according to the embodiment of the present disclosure may train an artificial intelligence model using this time information.

According to the present disclosure, by using the response information including the time information, the time it takes a user to solve an exercise may be effectively reflected in predicting the correct answer probability. In addition, there is the effect of predicting the correct answer probability by reflecting the forgetting effect over time.

An elapse time refers to the time it takes a user to solve an exercise. A lag time refers to the time it takes a user to start solving a subsequent exercise after completing solving of a previous exercise.

According to an embodiment, the time information may include elapse time information and lag time information. However, the time information is not limited thereto, and various types of information that may indicate temporal characteristics of a user's operation related to exercise solving may be included.

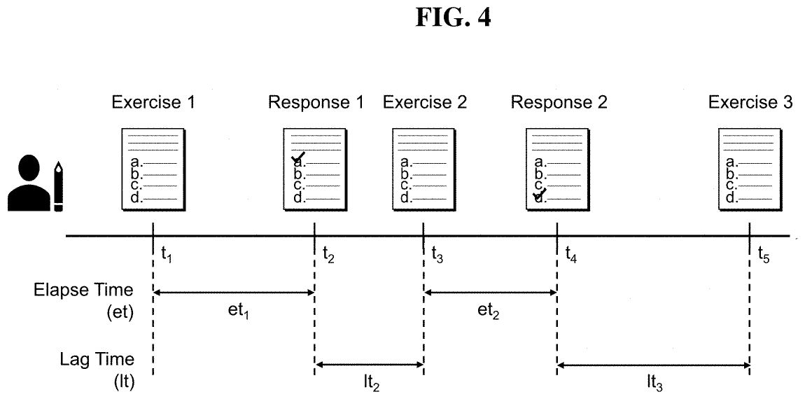

The elapse time refers to the time a user spends solving one exercise. The lag time refers to the time it takes the user to start solving the subsequent exercise after the user completes solving the previous exercise. Here, for a more detailed description of the elapse time and the delay time, reference will be made to FIG. 4.

FIG. 4 is a diagram for describing the elapse time and the lag time according to the embodiment of the present disclosure and is a diagram illustrating a time table for a case in which a user solves “exercise 1” to “exercise 3.”

Referring to FIG. 4, the user solves the “exercise 1” for a time from t₁ to t₂ and solves the “exercise 2” for a time from t₃ to t₄. Further, the solving of the “exercise 3” starts from t₅. Referring to FIG. 4, it can be seen that an elapse time (et₁) for the “exercise 1” is longer than an elapse time (et₂) for the “exercise 2.” It can be seen that a lag time (lt₂=t₃−t₂) for “exercise 2,” that is, the time from the time t₂ when the user completes the solving of the “exercise 1” to the time t₃ when the solving of the “exercise 2” starts is shorter than the lag time for the “exercise 3” (lt₃=t₅−t₄), that is, the time from the time Li when the user completes the solving of the “exercise 2” to the time t₅ when the solving of the “exercise 3” starts.

Referring back to FIG. 3, the embedding performing unit 220 may perform embedding on the time information included in the response information. The embedding refers to vectorizing the time information included in the response information so that the artificial intelligence model may understand the time information.

In the above embodiment, the embedding performing unit 220 may perform embedding on the elapse time information and the lag time information to input the vectorized elapse time information and the vectorized lag time information to the knowledge tracking model.

In the artificial neural network, embedding means making a vector with a lower dimension than the original dimension. The embedding of the artificial neural network turns thousands of or tens of thousands of high-dimensional variables into hundreds of low-dimensional variables.

The embedding is useful because it has sufficiently categorical meaning in the transformed low-dimensional space. Through the embedding, the artificial neural network may find the nearest neighbor information or visualize a concept and relevance between categories and provide the visualized concept and relevance to a user.

The embedding performing unit 220 may embed time information using one or more embedding methods of numerical embedding or categorical embedding. To this end, the embedding performing unit 220 may include a numerical embedding performing unit 221 and a categorical embedding performing unit 222.

The numerical embedding performing unit 221 may generate an embedding vector by placing at least one learnable time information vector in the artificial intelligence model and calculating a time value on a time information vector.

For example, it is assumed that it takes 20 seconds for a user to solve an exercise and a preset vector corresponding to an elapse time is [1, −1, 3]. In this case, the information “20 seconds” is vectorized as 20*[1, −1, 3]=[20, −20, 60]. However, the calculation of the time value is not limited to multiplication, and various calculation methods may be used according to embodiments.

The categorical embedding performing unit 222 may embed each time unit into different time information vectors after dividing time information into time units of a preset unit. The time information vectors may be input to the knowledge tracking model after undergoing a preset calculation process.

For example, after the user's elapse time is rounded up and expressed as an integer, the time from 1 second to 300 seconds may be embedded into 300 different vectors. In this case, any time exceeding 300 seconds may be regarded as 300 seconds.

The vectors (embedding vectors) generated by the numerical embedding performing unit 221 and/or the categorical embedding performing unit 222 are all added and transmitted when input to the knowledge tracking model, and the knowledge tracking model may predict a student's correct answer probability for an exercise based on the vectors.

In an embodiment, the embedding performing unit 220 may determine an embedding method based on parameters extracted from the exercise information and the response information. The parameter may include, but is not limited to, the average number of exercises solved by a user, an average or a variance value of the collected time information distribution, and quantified user ability.

As an example, the embedding performing unit 220 may determine that the number of embedding vectors of the time information is too large when the average number of exercises solved by a user is greater than or equal to a reference value. In this case, the embedding performing unit 220 may perform categorical embedding having the predetermined number of embedding vectors instead of performing numerical embedding in which one embedding vector is generated for each solving time.

As another example, the embedding performing unit 220 may determine that the number of embedding vectors of time information is small when the variance value of the time information distribution is less than or equal to a reference value. In this case, the embedding performing unit 220 may perform the numerical embedding capable of generating the embedding vectors relatively finely, instead of performing the categorical embedding having the predetermined number of embedding vectors.

In the above description, it has been mainly described that the embedding performing unit 220 performs embedding on the time information included in the response information. However, the target performing the embedding is not necessarily limited to time information. That is, it can be understood that the embedding performing unit 220 performs embedding on each of the exercise information and the response information but selectively performs one of the numerical embedding and the categorical embedding on the time information included in the response information based on the parameters extracted from the exercise information and the response information.

The model training unit 230 may train the knowledge tracking model by the method of inputting the embedded exercise information and the embedded response information to the knowledge tracking model and adjusting the weight indicating the relationship between the time information included in the response information and the user's correct answer probability.

The knowledge tracking model may be trained to predict the correct answer probability of the user for an arbitrary exercise that the user has not yet solved based on the weight determined as a result of the training.

The model training unit 230 may train the knowledge tracking model in a direction in which it is determined that a user's ability is lower as the elapse time is longer, and the predicted correct answer probability is adjusted downward.

After the user completes solving of one exercise, the user waits for a predetermined time without solving an exercise until starting to solve a subsequent exercise. For example, as illustrated in FIG. 4, a user has the lag time (lt₂=t₃−t₂) until starting to solve the “exercise 2” after completing the solving of the “exercise 1.” The user has the lag time (lt₃=t₅−t₄) until starting to solve the “exercise 3” after completing the solving of the “exercise 2.”

The model training unit 230 determines that the user has forgotten part of the previously learned content as the lag time becomes longer. The knowledge tracking model may be trained in the direction in which the predicted correct answer probability is adjusted downward.

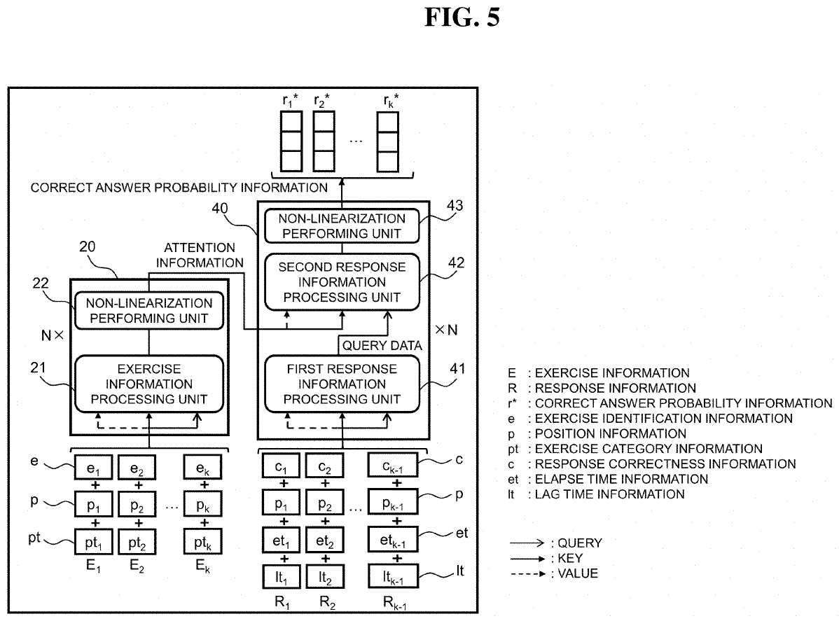

FIG. 5 is a diagram for describing an operation of a transformer structure-based artificial neural network according to an embodiment of the present disclosure.

Referring to FIG. 5, the knowledge tracking model may include an encoder 20 and a decoder 40. An exercise information stream is input to the encoder 20. A response information stream and an output of the encoder 20 are input to the decoder 40.

More specifically, the encoder 20 may include an exercise information processing unit 21 and a non-linearization performing unit 22. In addition, the decoder 40 may include a first response information processing unit 41, a second response information processing unit 42, and a non-linearization performing unit 43.

The exercise information stream may be composed of a plurality of pieces of exercise information (E₁, E₂, . . . , Eₖ) expressed as a vector. The response information stream may be composed of pieces of user response information (R₁, R₂, . . . , Rₖ₋₁) for each of the plurality of pieces of exercise information (E₁, E₂, . . . , Eₖ₋₁) expressed as a vector. The correct answer probability information may be composed of pieces of user's correct answer probability information (r₁*, r₂*, . . . , rₖ*) for each of the pieces of exercise information expressed as a vector.

In an embodiment, when the user response information to the exercise information “E₁” is “R₁”, the user response information to the exercise information “E₂” is “R₂,” . . . , and the user response information to the exercise information “Eₖ₋₁” is “Rₖ₋₁,” the user's correct answer probability to the exercise information “Eₖ” may be “rₖ*.” That is, when the exercise information “Eₖ” is presented to the user, the probability that the user answers the exercise information “Eₖ” correctly is “rₖ*.”

The exercise information processing unit 21 may receive an exercise information stream and perform a series of operations related to self-attention. These operations may include a process of classifying the exercise information E into a query vector, a key vector, and a value vector, a process of generating a plurality of head values for each divided vector value, a process of generating attention weights from a plurality of query head values and a plurality of key head values, a process of performing masking on the generated attention weights, and a process of generating prediction data by applying the masked attention weights to the plurality of value head values.

The prediction data generated by the exercise information processing unit 21 may be the attention information.

In particular, the exercise information processing unit 21 may perform upper triangular masking, as well as key-query masking, during the masking operation. According to an embodiment, after the key-query masking is performed, the upper triangular masking may be performed. According to another embodiment, the key-query masking and the upper triangular masking may be performed simultaneously. According to another embodiment, the upper triangular masking may be performed first, and the key-query masking may be performed. Hereinafter, for convenience of description, the example case in which the key-query masking is performed and then the upper triangular masking is performed will be described.

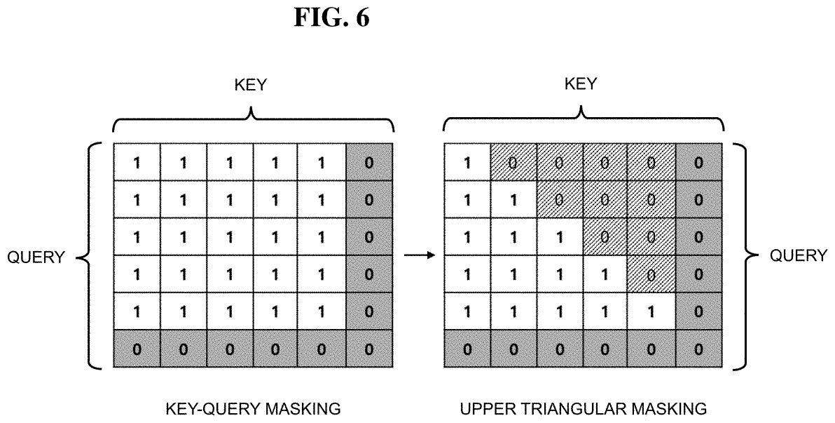

FIG. 6 is a diagram for describing the key-query masking and the upper triangular masking.

The key-query masking may be an operation that prevents execution of the attention by imposing a penalty to the null value (zero padding). The value of the prediction data on which the key-query masking is performed may be expressed as “0,” and the value of the prediction data on which the key-query masking is not performed may be expressed as “1.” Although the key-query masking of FIG. 6 exemplifies the case in which the last values of the query and the last values of the keys are masked, the masked values may be variously changed.

The upper triangular masking may be an operation that prevents execution of the attention on information corresponding to a future position in order to predict the correct answer probability for the subsequent exercise. Specifically, the upper triangular masking may be an operation for preventing the value of the prediction data from being calculated from an exercise that the user has not yet solved. Like the key-query masking, the value of the prediction data on which the upper triangular masking is performed may be expressed as “0,” and the value of the prediction data on which the upper triangular masking is not performed may be expressed as “1.”

Thereafter, the values of the masked prediction data may be controlled to have a probability close to zero when an arbitrary large negative value is reflected and expressed probabilistically through a softmax function.

Referring back to FIG. 5, the non-linearization performing unit 22 may perform an operation of non-linearizing the prediction data output from the exercise information processing unit 21. A rectified linear unit (ReLU) function (gradient function) may be used for the non-linearization but is not limited thereto.

As described above, there may be one or more encoders 20. FIG. 5 illustrates that there may be N encoders 20. In this case, the attention information generated by the encoder 20 is fed back to the encoder 20 so that a series of operations related to the self-attention and non-linearization may be repeated several times.

Meanwhile, the attention information generated by the encoder 20 may be divided into a key vector and a value vector and input to the second response information processing unit 42. The attention information may be used as a weight for the query data input to the second response information processing unit 42 and used to train the knowledge tracking model.

The first response information processing unit 41 may receive the response information stream and perform a series of operations related to the self-attention similar to the exercise information processing unit 21. These operations may include a process of classifying the exercise information E into a query vector, a key vector, and a value vector, a process of generating a plurality of head values for each divided vector value, a process of generating attention weights from a plurality of query head values and a plurality of key head values, a process of performing masking on the generated attention weights, and a process of generating prediction data by applying the masked attention weights to the plurality of value head values.

The prediction data generated by the first response information processing unit 41 may be query data.

The second response information processing unit 42 may receive the query data from the first response information processing unit 41, receive the attention information from the encoder 20, and output the correct answer probability information rₖ*.

The attention information is input to the decoder 40 and then may be used as a weight for the query data input to the decoder 40 and used to train the knowledge tracking model.

The attention information may be information on a weight assigned to focus on a specific area of query data. Specifically, the knowledge tracking model may re-consider all pieces of the input data (E₁, E₂, . . . , Eₖ, R₁, R₂, . . . , Rₖ₋₁) of the encoder 20 whenever the decoder 40 predicts the output result rₖ* and may pay attention to data related to the corresponding output result.

According to the above operation, the second response information processing unit 42 may generate “rₖ*” which is information on the user's correct answer probability for the exercise information “Eₖ”.

As described above, there may be one or more decoders 40. FIG. 5 illustrates that there may be N decoders 40. In this case, the correct answer probability information r* generated by the decoder 40 is fed back to the decoder 40, and thus, a series of operations related to self-attention, multi-head attention, and non-linearization may be repeated several times.

On the other hand, the exercise information processing unit 21, the first response information processing unit 41, and the second response information processing unit 42 may perform the upper triangular masking, as well as the key-query masking, during the masking operation.

In an embodiment of the present disclosure, the exercise information E₁, E₂, . . . , Eₖ may be input to the encoder 20 in the form of a vector on which the embedding is performed. As illustrated in FIG. 5, the exercise information E may include exercise identification information (Exercise ID, e), exercise position information (Position, p), and exercise category information (Exercise Category, pt).

The exercise identification information (Exercise ID, e) may be unique information assigned to each exercise. The user or computer may determine which exercise the corresponding exercise is through the exercise identification information.

The exercise category information (Exercise Category, pt) may be information indicating which type or part of the exercise the corresponding exercise is. For example, in the TOEIC®, the exercise category information may be information indicating whether a predetermined exercise is an exercise belonging to a listening part or an exercise belonging to a reading part. When a certain exercise in the TOEIC belongs to the listening part, exercise category information on the exercise may be “Part 1.” When a certain exercise in the TOEIC belongs to the listening part, exercise category information on the exercise may be “Part 2.”

The exercise position information (Position, p) may be information indicating where the predetermined exercise information E is positioned in the exercise information stream, that is, among all pieces of the exercise information. In the transformer structure, unlike the RNN structure, since input data is not sequentially input, it is necessary to separately indicate where each input data is positioned in the entire input sequence.

The above-described exercise identification information (e), exercise category information (pt), and exercise position information (p) may be embedded together, and each embedded information may be summed and input to the encoder 20.

In the embodiment of the present disclosure, the pieces of the response information R₁, R₂, . . . , Rₖ₋₁ may be input to the decoder 40 in the form of an embedded vector. As illustrated in FIG. 5, the response information R may include response correctness information (Response Correctness, c), response position information (Position, p), elapse time information (Elapse Time, et), and lag time information (Lag Time, lt).

The response correctness information (Response Correctness, c) may be information indicating whether the user's response is a correct or incorrect answer. For example, when the user's response is the correct answer, the response correctness information may be expressed as a vector indicating “1.” Conversely, when the user's response is an incorrect answer, the response correctness information may be expressed as a vector indicating “0”.

The response position information (Position, p) may be information indicating where the predetermined response information (R) is located in the response information stream, that is, the entire response information. In the transformer structure, unlike the RNN structure, since pieces of input data are not sequentially input, it is necessary to separately indicate where each piece of input data is positioned in the entire input sequence.

The elapse time information (Elapse Time, et) may be information expressing a time it takes a user to solve an exercise as a vector. The elapse time information may be expressed in seconds, minutes, hours, and the like. In addition, when the time taken to solve the exercise exceeds a reference time, the elapse time may be determined based on the reference time. For example, when the reference time is 300 seconds and the time it takes to solve an exercise exceeds 300 seconds, the elapse time for the exercise may be determined to be 300 seconds.

The lag time information (Lag Time, lt) may be the time from the time the user finishes solving the previous exercise to the time the user starts solving the subsequent exercise. However, in the embodiment, the lag time information may include information indicating the time when the user solves the exercise. In this case, the lag time information may be expressed as time, day, month, year, or the like.

The above-described response correctness information (c), response position information (p), elapse time information (et), and lag time information (lt) may be embedded together, and each piece of embedded information may be summed and input to the decoder 40.

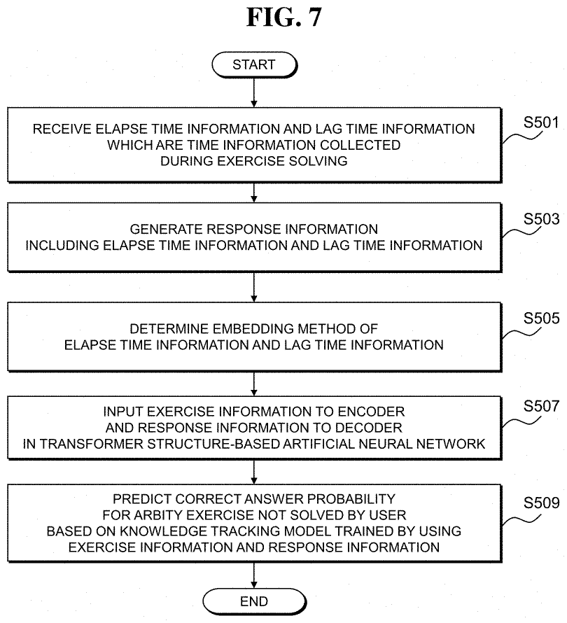

FIG. 7 is a flowchart for describing an operation of the user knowledge tracking device according to the embodiment of the present disclosure.

Referring to FIG. 7, in operation S501, the user knowledge tracking device 200 may collect the time information collected in the process of solving the exercise from the user terminal 100. The time information may include the elapse time information and the lag time information. The elapse time information refers to the time it takes a user to solve an exercise. The lag time information refers to the time until the user starts solving the subsequent exercise after responding to the previous exercise.

In operation S503, the user knowledge tracking device 200 may generate the response information R including the elapse time information and the lag time information. The response information R may further include one or more of the response correctness information and the response position information in addition to the elapse time information and the lag time information.

In operation S505, the user knowledge tracking device 200 may determine an embedding method of the elapse time information and the lag time information.

Specifically, the user knowledge tracking device 200 may determine the embedding method based on parameters extracted from the exercise information E and the response information R. The parameter may include, but is not limited to, the average number of exercises solved by a user, the average or variance value of the collected time information distribution, the user's ability, or the like.

The user knowledge tracking device 200 may select an embedding method of any one of the numerical embedding and the categorical embedding based on the extracted parameters and embed the time information using the selected embedding method.

In operation S507, the user knowledge tracking device 200 may input the exercise information E to the encoder 20 of the transformer structure-based artificial intelligence model and input the response information R to the decoder 40 of the transformer structure-based artificial intelligence model.

In operation S509, the user knowledge tracking device 200 predict the user's correct answer probability r* for an arbitrary exercise that the user has not yet solved based on the knowledge tracking model trained by using the exercise information E and the response information R.

Hereinabove, the embodiments of the present disclosure have been described with reference to FIGS. 1 to 7. In the above-described example, the user knowledge tracking device 200 may be a computing device including one or more processors. In addition, components constituting the user knowledge tracking device 200 may be implemented as a module.

The module refers to software or hardware components such as a Field Programmable Gate Array (FPGA) or Application Specific Integrated Circuit (ASIC), and the module performs certain roles. However, the module is not limited to the software or the hardware. The module may be configured to be in an addressable storage medium or may be configured to execute one or more processors. Therefore, as an example, the module includes components such as software components, object-oriented software components, class components and task components, processes, functions, attributes, procedures, subroutines, segments of program code, drivers, firmware, a microcode, a circuit, data, a database, data structures, tables, arrays, and variables. The functions provided by the components and modules may be combined into a smaller number of components and modules or further divided into additional components and modules.

According to a user knowledge tracking device, a system, and an operating method thereof according to an embodiment of the present disclosure, it is possible to predict a correct answer probability with higher accuracy by using a transformer structure-based artificial intelligence model as a knowledge tracking model which is trained by inputting exercise information to an encoder and response information to a decoder in the knowledge tracking model to predict the correct answer probability based on the trained knowledge tracking model.

In addition, according to a user knowledge tracking device, a system, and an operating method thereof according to an embodiment of the present disclosure, it is possible to predict a correct answer probability to a particular exercise with higher accuracy by training a knowledge tracking model based on time information related to a student's response such as a time it takes a user to solve an exercise and a lag time which is a time it takes to start solving a subsequent exercise after a previous exercise has solved.

In addition, according to a user knowledge tracking device, a system, and an operating method thereof according to an embodiment of the present disclosure, it is possible to predict a correct probability more efficiently by determining an embedding method of time information based on parameters extracted from exercise information and response information, such as the average number of exercises that a user has solved and an average and variance value of collected time information distribution.

The effects of the present disclosure are not limited to the above-described effects, and other effects that are not described may be obviously understood by those skilled in the art from the above detailed description.

Although the embodiments of the present disclosure have been described hereinabove with reference to the accompanying drawings, those skilled in the art to which the present disclosure pertains will be able to understand that the present disclosure may be implemented in other specific forms without departing from the spirit or essential feature of the present disclosure. Therefore, it should be understood that the above-described embodiments are exemplary in all aspects but are not limited thereto.

What is claimed is:

1. A user knowledge tracking device for predicting a correct answer probability using time information related to exercise solving, the user knowledge tracking device comprising:
an exercise-response information storage unit configured to store exercise-response information that includes exercise information provided to a user for learning and response information to a solving record for an exercise solved by the user;
an embedding performing unit configured to receive the response information from the exercise-response information storage unit and perform embedding on time information included in the response information; and
a model training unit configured to input an embedded exercise information and response information to a knowledge tracking model and adjust a weight indicating a relationship between the time information included in the response information and a user's correct answer probability to train the knowledge tracking model for predicting a user's correct answer probability for an exercise that the user has not yet solved based on the weight.

2. The user knowledge tracking device of claim 1, wherein the embedding performing unit includes a numerical embedding performing unit that places at least one learnable time information vector in an artificial intelligence model and calculates a time value on the time information vector to generate an embedding vector.

3. The user knowledge tracking device of claim 2, wherein the embedding performing unit includes a categorical embedding performing unit that generates the embedding vector by a method of dividing the time information into a time unit of a preset unit and then embedding each time unit into a different time information vector.

4. The user knowledge tracking device of claim 3, wherein the time information includes elapse time information, which is a time it takes the user to solve an exercise, and lag time information, which is a time until the user solves a subsequent exercise after completing solving of a previous exercise.

5. The user knowledge tacking device of claim 4, wherein the model training unit trains the knowledge tracking model in a direction in which it is determined that user's ability is lower as an elapse time becomes longer, and the predicted correct answer probability is adjusted downward, and a direction in which it is determined that the user has forgotten a part of learned content, and the predicted correct answer probability is adjusted downward.

6. The user knowledge tracking device of claim 5, wherein the knowledge tracking model includes an encoder that receives the exercise information and a decoder that receives the response information, uses a transformer structure-based artificial intelligence model that considers all pieces of input data of the encoder whenever the decoder predicts an output result and pays attention to input data related to the correct answer probability to be predicted.

7. The user knowledge tracking device of claim 6, wherein the encoder includes:
an exercise information processing unit configured to receive the exercise information and perform a series of operations related to self-attention; and
a non-linearization performing unit configured to perform an operation of non-linearizing prediction data output from the exercise information processing unit.

8. The user knowledge tracking device of claim 6, wherein the decoder includes:
a first response information processing unit configured to receive the response information and perform a series of operations related to self-attention;
a second response information processing unit configured to receive query data from the first response information processing unit, receive attention information from the encoder, and output correct answer probability information on the received exercise information; and
a non-linearization performing unit configured to perform an operation of non-linearizing the correct answer probability information output from the second response information processing unit.

9. The user knowledge tracking device of claim 1, wherein the exercise information includes exercise identification information, which is unique information given to each exercise, exercise position information indicating where the exercise is positioned among all pieces of exercise information, and exercise category information indicating a type or part of the exercise.

10. The user knowledge tracking device of claim 1, wherein the response information includes response correctness information, which is information indicating whether a user's response is a correct or incorrect answer, response position information, which is information indicating where the user's response is positioned in entire response information, elapse time information, which is information on a time it takes the user to solve an exercise, and lag time information, which is information on a time until the user starts solving a subsequent exercise after completing solving of a previous exercise.

11. An operation method of a user knowledge tracking device for predicting a correct answer probability using time information related to exercise solving, the operation method comprising:
storing exercise-response information, which includes exercise information provided to a user for learning and response information to a solving record for an exercise solved by the user in an exercise-response information storage unit;
receiving the response information from the exercise-response information storage unit and performing embedding on time information included in the response information; and
inputting an embedded exercise information and response information to a knowledge tracking model and adjusting a weight indicating a relationship between the time information included in the response information and a user's correct answer probability to train the knowledge tracking model for predicting a user's correct answer probability for an exercise that the user has not yet solved based on the weight.
